(19) United States
(12) Patent Application Publication
(10) Pub. No.: US 2021/0310273 A1
(43) Pub. Date: Oct. 7, 2021

(54) FOOT-OPERATED DOOR OPENER

(71) Applicant: Wrist Handles LLC, Springfield, MO (US)

(72) Inventor: LARRY M. ASKREN, SPRINGFIELD, MO (US)

(21) Appl. No.: 17/221,353

(22) Filed: Apr. 2, 2021

Related U.S. Application Data
(60) Provisional application No. 63/023,571, filed on May 12, 2020.
(60) Provisional application No. 63/004,606, filed on Apr. 3, 2020.

(51) Int. Cl. E05B 1/00

(52) U.S. Cl. CPC E05B 1/0053; E05B 2001/0023; E05B 1/0015

(57) ABSTRACT

A foot operated door opener may be attached to or near a lower edge of a door to allow a user to open the door without touching it with their hands. The door opener may have a support member that holds a movable foot member or puck. The user engages the foot member with their foot to pull the door open. As the door opens the foot member pivots, rotates, or tilts with respect to the support member. The foot member may be provided with a flange that engages the support member, and the support member may be provided with a flange to engage the foot member. The support member may fold up against the door when not in use.

### CROSS-REFERENCE TO RELATED APPLICATIONS

This application claims the benefit of U.S. Patent Application Ser. No. 63/023,571 filed on May 12, 2020 and U.S. Patent Application Ser. No. 63/004,606 filed on Apr. 3, 2020, the disclosures of which are incorporated herein by reference.

### BACKGROUND

### Field of the Invention

This disclosure is in the field of openers for doors. More specifically, this disclosure is in the field of foot-operated door openers.

### SUMMARY OF THE INVENTION

In various embodiments, the foot-operated door opener comprises a support member mounted on a door by a mounting member. The support member movably supports a foot puck that allows a user to pull a door open using their foot. In some embodiments the support member may be folded to a stowed configuration when not in use.

### BRIEF DESCRIPTION OF THE DRAWINGS

FIG. 1A is a perspective view of an embodiment of the foot operated door opener attached to a door.

FIG. 1B is a detail perspective view of an embodiment of the foot operated door opener attached to a door.

FIG. 2A is a top plan view of an embodiment of the foot operated door opener.

FIG. 2B is a side plan view of an embodiment of the foot operated door opener.

FIG. 2C is an end plan view of an embodiment of the foot operated door opener.

FIG. 3 is a partially exploded view of an embodiment of the foot operated door opener.

FIG. 4A is a side plan view of an embodiment of the foot operated door opener.

FIG. 4B is a cross-sectional view of an embodiment of the foot operated door opener on axis H-H of FIG. 4A.

FIG. 5A is a side plan view of an embodiment of the foot operated door opener.

FIG. 5B is a side plan view of an embodiment of the foot operated door opener.

FIG. 6A is a cross-sectional view of an additional embodiment of the foot operated door opener.

FIG. 6B is a side plan view of an additional embodiment of the foot operated door opener.

FIG. 6C is a cross-sectional view of the embodiment of FIG. 6B along axis A-A.

FIG. 6D is a side plan view of an additional embodiment of the foot operated door opener.

FIG. 6E is a cross-sectional view of the embodiment of FIG. 6D along axis B-B.

FIG. 7A is a detail perspective view of a second embodiment of the foot operated door opener attached to a door in an operational configuration.

FIG. 7B is a detail perspective view of the second embodiment of the foot operated door opener attached to a door in a stowed configuration.

FIG. 7C is a side plan view of the second embodiment of the foot operated door opener.

FIG. 8 is a perspective view of a third embodiment of the foot operated door opener.

### DETAILED DESCRIPTION

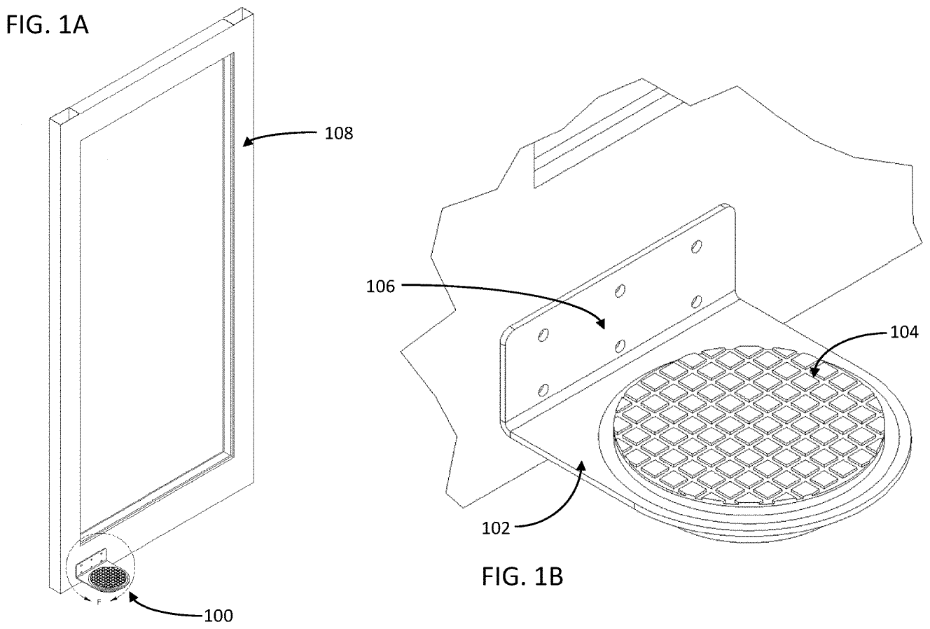

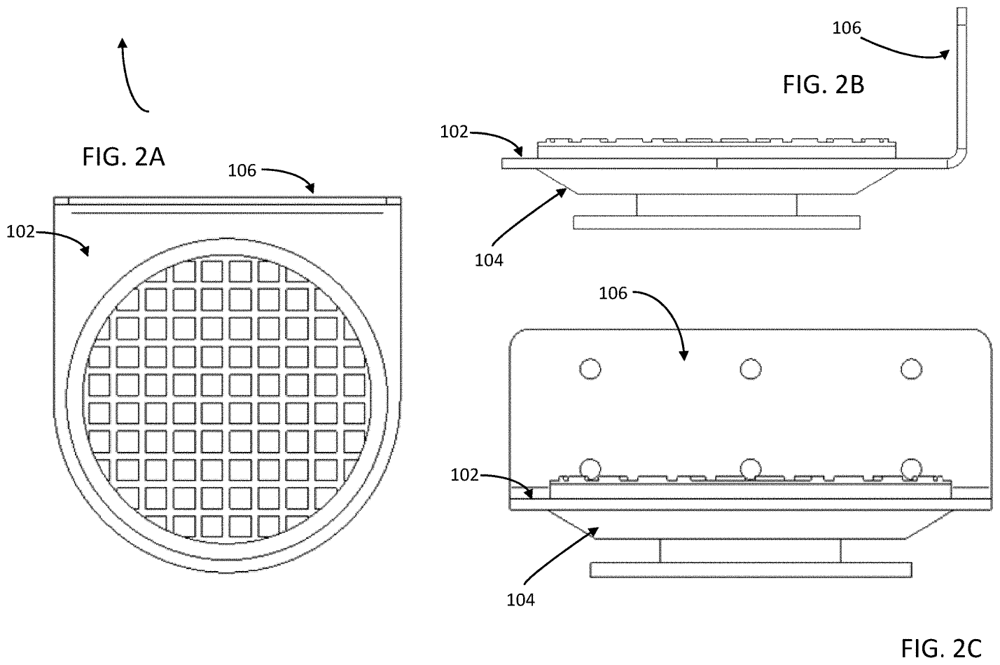

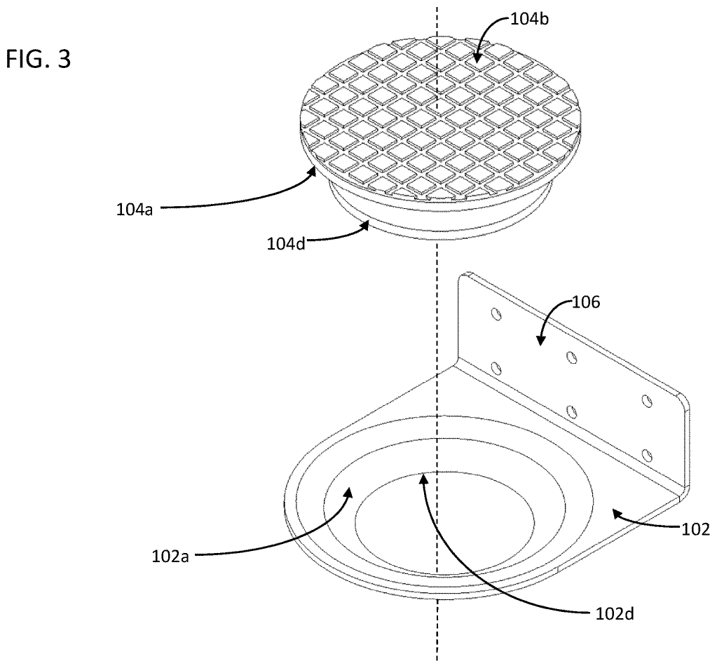

In certain circumstances it is desirable to be able to open a door using a foot-operated door opener. This allows a user to open a door without potential germ-transferring contact between their hands and a common door handle. It also allows a user to open a door while holding other items in their hands. Referring now to FIGS. 1 through 7, several embodiments of a foot-operated door opener are depicted in various views.

In the depicted embodiments, the door opener 100 comprises a support member 102 that provides support to a foot member, or “puck”, 104 movably disposed on the support member 102. The support member 102 is attached to a mounting member 106 for attaching the door opener 100 to a door. A user may pull a door open by placing one foot on the foot member 104, tilting the foot member 104 in relation to support member 102, and pulling back on foot member 104 away from the door.

In the embodiment depicted in FIGS. 1A through 5B inclusive, the mounting member 106 mounts to a side surface of a door 108 by screws, bolts, or other means of attachment on mounting plate 106. In some embodiment, the mounting member 106 has an optional bottom plate 106b and an optional outside plate 106c to wrap under and to the other side of the door 108. In some embodiments, bolts or machine screws may attach mounting plate 106 to an outside plate 106c on the opposing side of the door 108 through the door 108 for added support. In a typical installation, the door opener 100 is attached to the lower portion of a door 108 and disposed away from the hinge side of the door 108.

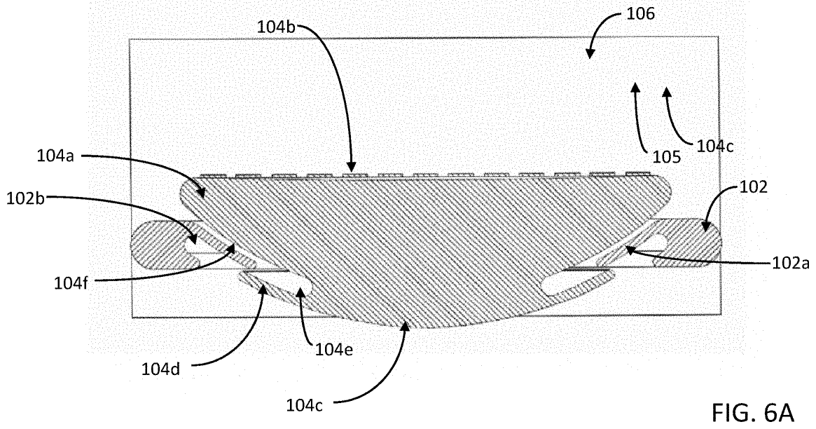

The support member 102 provides support to foot member 104 but allows it to tilt, pivot, rotate, or otherwise move with respect to support member 102 as particularly shown in FIGS. 5A and 5B. This allows the position of the foot member 104 to adjust to an appropriate angle based on the position of the user's foot and their location with respect to the door. It also allows the foot member 104 to stay fixed in relationship to a user's foot while the door and support member pivot or rotate with respect to the user's foot as the door opens. The ability of the foot member 104 to change orientation with respect to the support member 102 as the door opens provides for a smooth opening motion for a user. The adjusting orientation of the foot member 104 to the support member 104 may be accomplished using a number of mechanisms that a person of skill in the art may identify such as rotatable, pivotal, or tilting attachments between two or more components of the device 100. Some preferred embodiments are depicted in this application, but the scope of the claimed inventive device is not limited to the embodiments shown in the figures.

The support member 102 may be made up of one or more component parts and may be fixed to or removable from the mounting member 106. The attachment between the support member 102 and the mounting member 106 may be welded attachments, screw or bolt attachment, adhesive attachment, or integrally formed using printing, casting, or machining as a single piece of material. The component parts of the door opener 100 may be formed from any material with suitable strength and other characteristics sufficient to provide the functions described herein, including various metals, plastics, composites, or other materials. In the depicted embodiments, the support member 102 has a substantially circular opening with edge 102d for receiving the foot member 104. In this embodiment an inclined bearing surface 102a extends around the edge 102d of support member 102 adjacent to the circular opening or aperture. In this embodiment, the inclined bearing surface 102a extends around the entire edge 102d of the opening to allow the foot member 104 to rotate through 360 degrees and to tilt in any direction. In some embodiments, the inclined bearing surface 102a may only extend along a portion of the edge 102d of the opening. In such embodiments the foot member 104 may only rotate for less than 360 degrees or tilt in a narrower range of directions. In other embodiments the opening may be non-circular in shape or have both arcuate and non-arcuate sections. In other embodiments there may be no aperture in the support member 102, and the foot member 104 may rest on top of the support member 102.

The foot member 104 is movably disposed on the support member 102. In the depicted embodiment a top member 104a forms the top portion of the foot member 104. The upper surface of the top member 104a may be provided with features 104b to increase the friction between the foot member 104 and a user's shoe or foot during use. The features 104b may be formed as part of top member 104a or attached to it. In varying embodiments of the device, all or a portion of the bottom surface of top member 104a comprises one or more bearing surfaces 104f. The bearing surface 102a of support member 102 receives the bearing surface 104f of the top member 102a. In the depicted embodiment the bearing surfaces 102a and 104f are slidably engaged. In other embodiments they may be provide with ball bearings or other means of reducing friction while allowing movement between the support member 102 and the foot member 104. In this embodiment the bearing surfaces 102a and 104f are substantially spherical segments. In other embodiments they may be ovoid, ellipsoid, oblate spheroids, spherical, frusto-conical, or other surface configurations that will allow a desired ability to tilt or rotate.

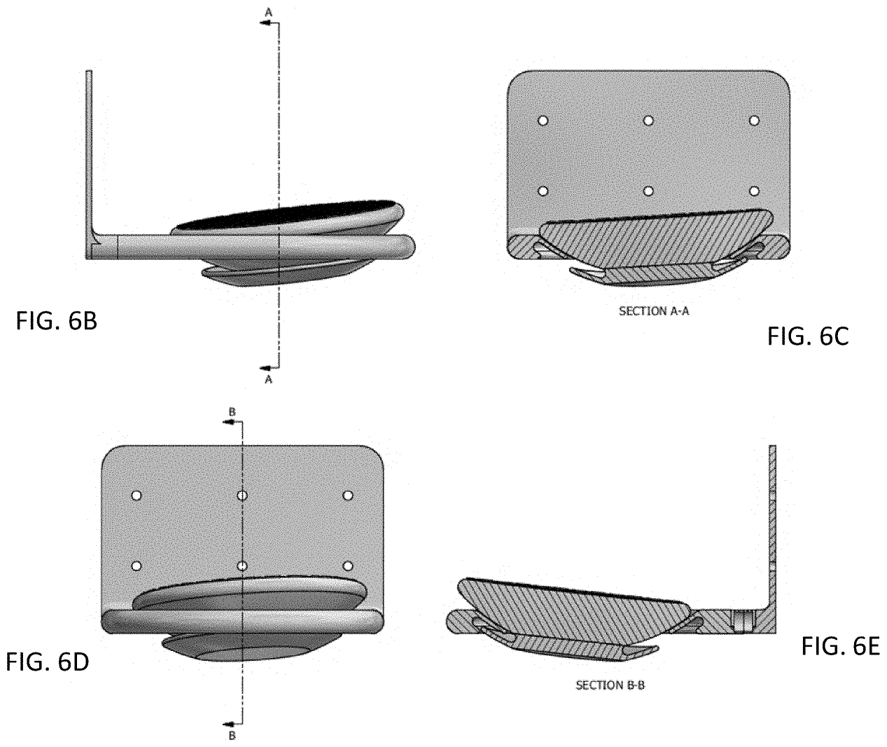

Referring to the embodiment depicted in FIGS. 6A through 6E, a preferred embodiment of the foot-operated door opener is depicted. This embodiment has bearing surfaces 104f and 102a that are substantially spherical, spherical sectors, or other sections of a spherical surface. In this embodiment flange 104d and the bottom surface 104c are also substantially spherical or sections of a spherical surface. Also this embodiment has a pocket 102b in support member 102 for receiving flange 104d when the foot member 104 slides or pivots to the side.

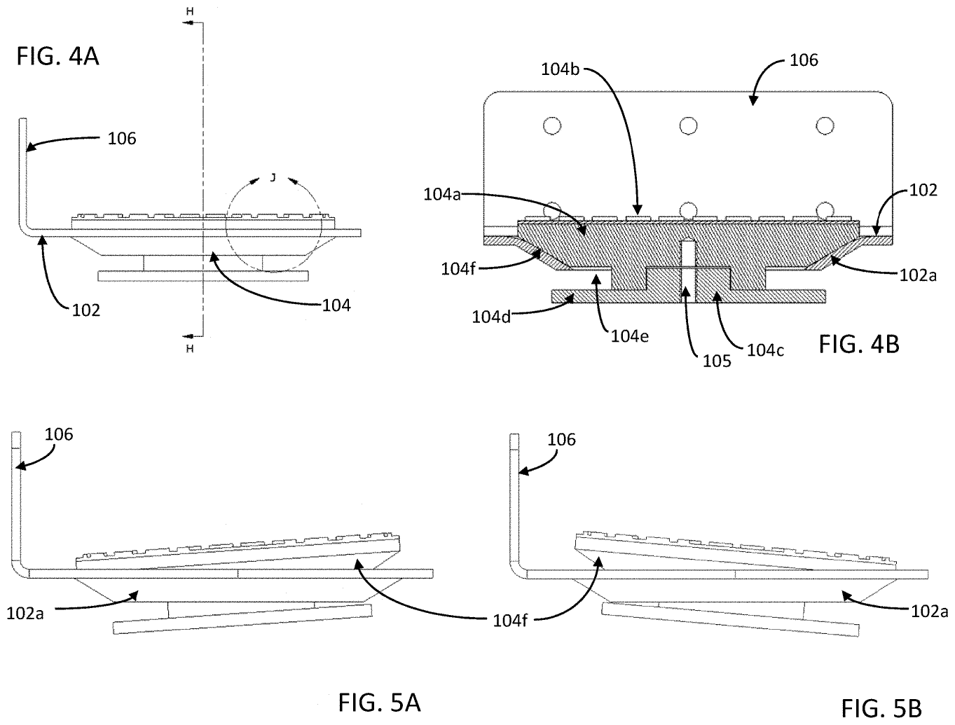

The foot member 104 may also be provided with a bottom member 104c. In some embodiments the bottom member 104c may be attached to the bottom surface of top member 104a or formed unitarily with top member 104a. In the embodiment depicted in FIG. 4B, a threaded bolt 105 affixes bottom member 104c to top member 104a. In some embodiments the bottom member 104c may have flanges 104d that forms a socket 104e between the bearing surface 104f and the bottom member 104c. Similarly, a socket may be provided in the support member 102 that defines a flange. In some embodiments, as the foot member 104 moves within the allowed range, the flange may be disposed all or partially within the socket 104e.

In some embodiments the bottom surface of bottom member 104c may provide additional support to the foot-operated door opener by contacting the floor. The bottom surface of bottom member 104c may slide along the floor as the user operates the door opener. This prevents excessive downward torque on the mounting member 106 and door 108. The bottom surface 104c may be flat or curved. In a preferred embodiment the bottom surface 104c is a section of sphere such as a spherical sector, spherical cap, or a dome.

In some embodiments when the foot member 104 moves away from a center position the component 102a is within socket 104e on one side of the foot member 104, while on the other side of the foot member 104 the flange 102a is not within the socket 104e at all. This engagement of the flanges and sockets helps prevent the foot member 104 from moving past a desired range of motion or from becoming disengaged from the support member 102.

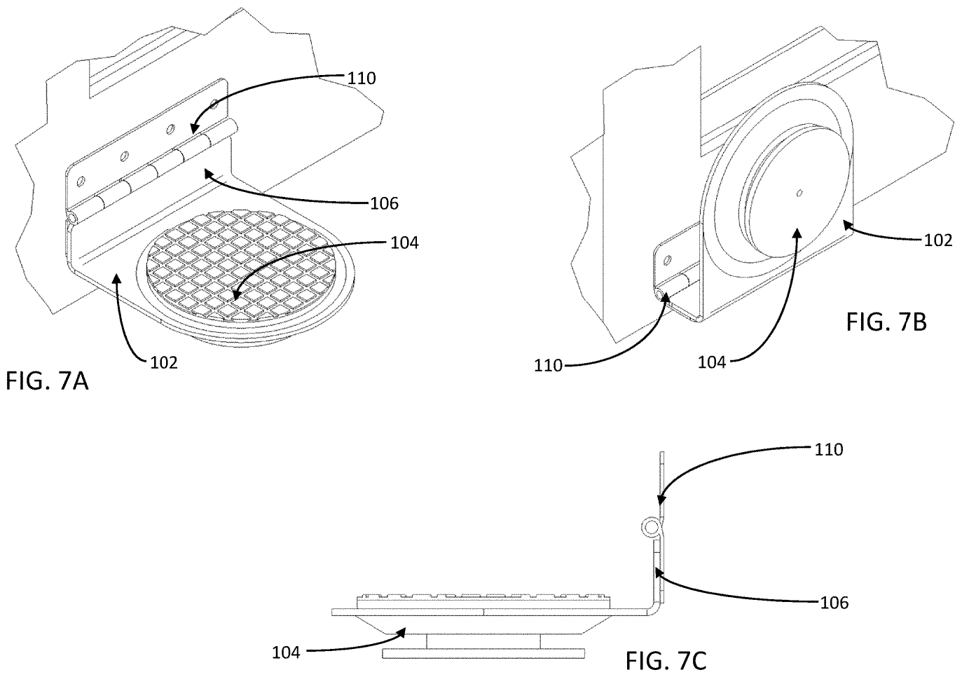

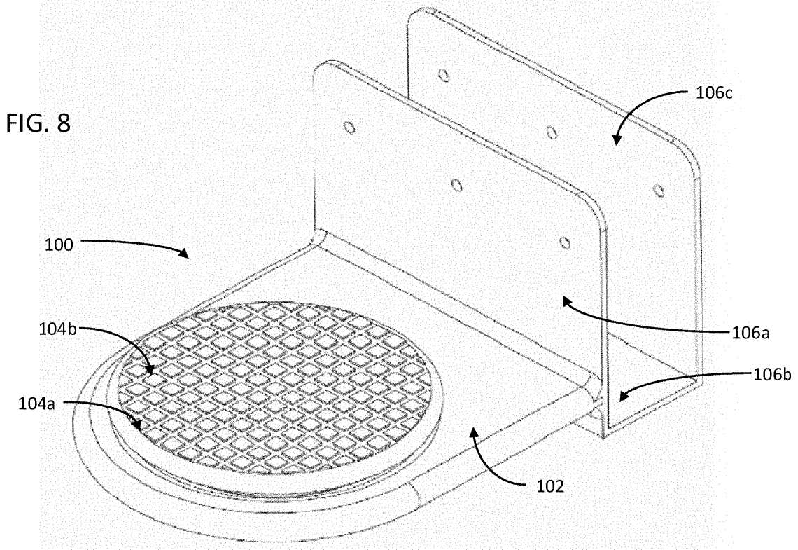

As can be seen with reference to FIGS. 7A-7C, in other embodiments the mounting member 106 may be attached to the door 108 by a hinge 110 or other pivotal mechanism. In other embodiments the support member 102 may be pivotally attached to the mounting member 106 by a hinge 110 or other pivotal mechanism. In some of these embodiments the mounting member 106 may be provided with a hinge block attached to or formed as part of the mounting member 106. The hinge block may be provided with threaded holes or other means of fastening a hinge 110 or other pivotal mechanism to the mounting member 106. In the depicted embodiment one leaf of the hinge is welded to the mounting member 106. In other embodiment, the support member 102 may be attached to a hinge 110 that is attached to the hinge block on mounting member 106.

In this embodiment the hinge pin is disposed above or near the top edge of the support member 106 in the operational configuration shown in FIG. 7A. As a result, downward pressure by a user on the foot member 104 does not cause substantial further downward pivoting of the support member 102 beyond the position shown in FIG. 7A.

FIG. 7b depicts the hinged embodiment in a stowed configuration that reduces the space taken by the foot-operated door opener when it is not in use. Since the support member 102 extends outwardly from the door it may be desirable to fold it up against the door. In the depicted embodiment, the hinge 110 allows the pivoting of the mounting member 106 upwardly toward the door to the stowed position shown in FIG. 7B. In some embodiments the support member may be disposed upwardly to the stowed configuration by a biasing mechanism such as a spring, or it may be releasable held in the stowed position by a catch device or other similar mechanism.

In some embodiments the mounting member 102 and the support member 106 are approximately 6 inches wide. In some embodiments, the mounting member 102 may extend 6 to 7 inches from the mounting member 106. In some embodiments the mounting member is approximately 2 to 4 inches tall. All of the dimensions may vary from embodiment to embodiment so long as they accommodate the intended use of the device to allow a user to engage the foot puck and exert pressure on it to pull the door open.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A foot-operated door opener comprising a mounting member for attachment to a door, a support member attached to the mounting member, and a foot member disposed on the support member; wherein the foot member tilts or rotates with respect to the support member as a user operates the foot-operated door opener.

2. The foot-operated door opener of claim 1 wherein the support member further comprises an aperture and a bearing surface disposed adjacent to the aperture.

3. The foot-operated door opener of claim 2 wherein the aperture comprises a substantially circular aperture and the bearing surface comprises a substantially spherical surface around the substantially circular aperture.

4. The foot-operated door opener of claim 2 wherein the foot member comprises a foot bearing surface and a bearing surface for movably engaging the bearing surface of the support member.

5. The foot-operated door opener of claim 1 wherein the bearing surface of the foot member comprises a substantially spherical surface that movably engages the bearing surface of the support member.

6. The foot-operated door opener of claim 1 wherein the support member further comprises a first bearing surface adjacent to the aperture, and the support member further comprises a second bearing surface for movably engaging the first bearing surface.

7. The foot-operated door opener of claim 6 wherein the first bearing surface and the second bearing surface are substantially spherical surfaces.

8. The foot-operated door opener of claim 6 wherein the first bearing surface and the second bearing surface are sections of a spherical surface.

9. The foot-operated door opener of claim 7 wherein the first bearing surface has an aperture for receiving a bottom component of the foot member; wherein the bottom component of the foot member is provided a flange extending below the support member.

10. The foot-operated door opener of claim 1 further comprising a hinge component for pivoting the door opener from a stowed configuration to an operational configuration.

11. A door opener operated by a user's foot, the door opener comprising a mounting member for attachment to a door, a support member attached to the mounting member, and a foot puck movably supported by the support member; wherein the foot puck is configured to be engaged by a user's foot to open a door.

12. The door opener of claim 11 wherein the foot puck moves with respect to the support member in response to pressure from a user's foot.

13. The door opener of claim 12 wherein the foot puck rotates with respect to the support member.

14. The door opener of claim 11 wherein the foot puck has a top surface for engagement by user's foot, and a first bearing surface for movably engaging the support member, and the support member has a second bearing surface for receiving the first bearing surface.

15. The door opener of claim 14 wherein the first bearing surface and the second bearing surface have topologies selected from the group consisting of frusto-conical sections and substantially spherical sections.

16. The door opener of claim 15 wherein the second bearing surface further comprises an aperture for receiving a bottom component of the foot puck for retaining the foot puck on the support member.

17. The door opener of claim 16 wherein the bottom component of the foot puck further comprises a flange.

18. The door opener of claim 12 wherein the foot puck remains fixed with respect to a user's foot as the door opens.

19. The door opener of claim 1 wherein the foot member remains fixed with respect to a user's foot as the door opens.

20. The door opener of claim 11 further comprising a hinge component for pivoting the support member and the foot puck from a stowed configuration to an operational configuration.
